(19) United States
(12) Patent Application Publication
(10) Pub. No.: US 2008/0005797 A1
(43) Pub. Date: Jan. 3, 2008

(54) Identifying malware in a boot environment

(75) Inventors: Scott A Field, Redmond, WA (US); Rohan R. Phillips, Redmond, WA (US); Alexey A. Polyakov, Sammamish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/480,774

(22) Filed: Jun. 30, 2006

(51) Int. Cl. G06F 12/14

(52) U.S. Cl. 726/24

(57) ABSTRACT

Generally described, the present invention is directed at identifying malware. In one embodiment, a method is provided that performs a search for malware during the boot process. More specifically, the method causes a software module configured to scan for malware to be initialized at computer start up. Then, in response to identifying the occurrence of a scanning event, the method causes the software module to search computer memory for data that is characteristic of malware. If data characteristic of malware is identified, the method handles the malware infection.

### BACKGROUND

As more and more computers and other computing devices are interconnected through various networks such as the Internet, computer security has become increasingly more important, particularly from invasions or attacks delivered over a network or over an information stream. As those skilled in the art and others will recognize, these attacks come in many different forms, including, but certainly not limited to, computer viruses, computer worms, system component replacements, Trojans, RootKits, spyware, denial of service attacks, even misuse/abuse of legitimate computer system features, all of which exploit one or more computer system vulnerabilities for illegitimate purposes. While those skilled in the art will recognize that the various computer attacks are technically distinct from one another, for purposes of the present invention and for simplicity in description, all malicious computer programs that spread on computer networks such as the Internet, will be generally referred to hereinafter as computer malware or, more simply, malware.

When a computer system is attacked or “infected” by computer malware, the adverse results are varied, including disabling system devices; erasing or corrupting firmware, applications, or data files; transmitting potentially sensitive data to another location on the network; shutting down the computer system; or causing the computer system to crash. Yet another pernicious aspect of many, though not all, computer malware is that an infected computer system is used to infect other computer systems that are communicatively connected by a network connection.

A traditional defense against computer malware and, particularly, against computer viruses and worms, is antivirus software. Most antivirus software identifies malware by matching patterns within data to what is referred to as a “signature” of the malware. Typically, antivirus software scans for malware signatures when certain events are scheduled to occur, such as when data is going to be written or read from a storage device on the computer. As known to those skilled in the art and others, computer users have ongoing needs to read and write data to storage devices such as a hard drive. For example, a common operation provided by some software applications is to open a file stored on a hard drive and display the contents of the file on a computer display. However, since opening a file may cause malware associated with the file to be executed, antivirus software typically performs a scan or other analysis of the file before the open operation is satisfied. If malware is detected, the antivirus software that performed the scan may prevent the malware from being executed, for example, by causing the open operation to fail.

Increasingly, malware is being distributed with one or more programs specifically designed to “hide” the malware from software designed to protect a computer (e.g., antivirus software, anti-spyware software, and the like). Similar to other types of applications installed on a computer, software designed to protect a computer from malware relies on services provided by an operating system. However, if a malware is able to infect components of a computer operating system or other low level components, the malware may control the information that is provided to software designed to protect a computer. Malware that is specifically designed to conceal data that is characteristic of malware on a computer will be generally referred to hereinafter as a “RootKit.”

For illustrative purposes and by way of example only, FIG. 1 depicts how a RootKit is able to control the information that is made available to software designed to protect a computer 100 from malware. As illustrated in FIG. 1, the computer 100 includes an application program 102, an operating system 104, a storage device 106, and a RootKit 108. Also, the operating system 104 includes an interface 110 that provides services in the form of an Application Programming Interface (“API”) to application programs installed on the computer 100. The application program 102 performs actions designed to protect the computer 100 from malware. For example the application program 102 may scan files for malware “on access” when a user attempts to access a file stored on the storage device 106. However, as illustrated in FIG. 1, the application program 102 performs operations in user mode and relies on services provided by the operating system 104 that operates, at least partially, in kernel mode. Moreover, the computer 100 is infected with the RootKit 108 that “hooks” into the operating system 104, where it intercepts calls used to perform basic functions on the computer 100. Stated differently, the RootKit 108 acts as a “man-in-the-middle,” monitoring and altering communications between the operating system 104 and application programs installed on the computer 100. If an application program, such as anti-virus software, attempts to list the contents of a directory containing one or more files used by the RootKit 108, the RootKit 108 will censor the file name from the list. Similarly, the RootKit 108 may hide entries in the system registry, process list, and the like, thereby controlling all of the information that the RootKit 108 wants hidden.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Generally described, aspects of the present invention are directed at identifying malware that uses program code activated in a boot environment to avoid being detected. In accordance with one embodiment, a method is provided that performs a search for malware during the boot process. More specifically, the method causes a software module configured to scan for malware to be initialized at computer startup. Then, in response to identifying the occurrence of a scanning event, the method causes the software module to search computer memory for data that is characteristic of malware. If data characteristic of malware is identified, functionality is implemented to prevent the malware from executing on the computer. As a result of performing a scan at computer startup, malware that performs obfuscation techniques to hide from antivirus software are identified.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of software components that are configured to perform functions of a modern computer and a RootKit that is designed to conceal malware;

FIG. 2 is a pictorial depiction of the computer with components that are configured to identify malware in a boot environment;

FIG. 3 is a pictorial depiction of an exemplary timeline that illustrates events performed at computer start up; and

FIG. 4 is an exemplary flow diagram of a software module that identifies malware during the boot process.

### DETAILED DESCRIPTION

Aspects of the present invention may be described in the general context of computer-executable instructions, such as program modules, being executed by a computer. Generally described, program modules include routines, programs, applications, widgets, objects, components, data structures, and the like that perform particular tasks or implement particular abstract data types. Moreover, the present invention may be implemented in distributed computing environments where tasks are performed by remote processing devices that are linked through a communications network. In a distributed computing environment, program modules may be located on local and/or remote computer storage media.

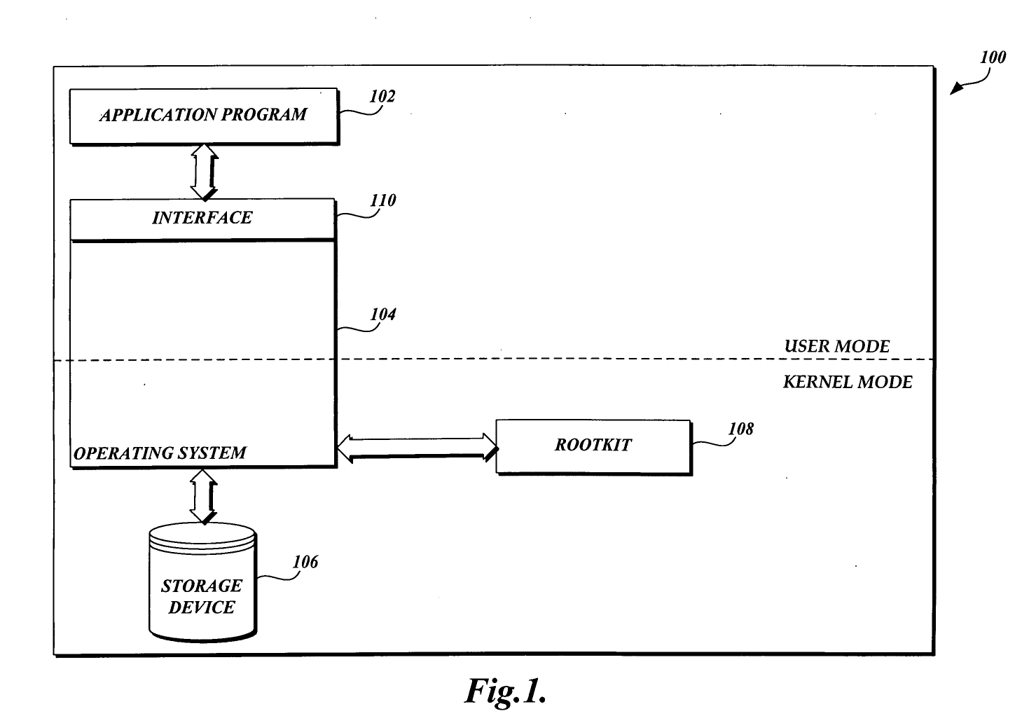

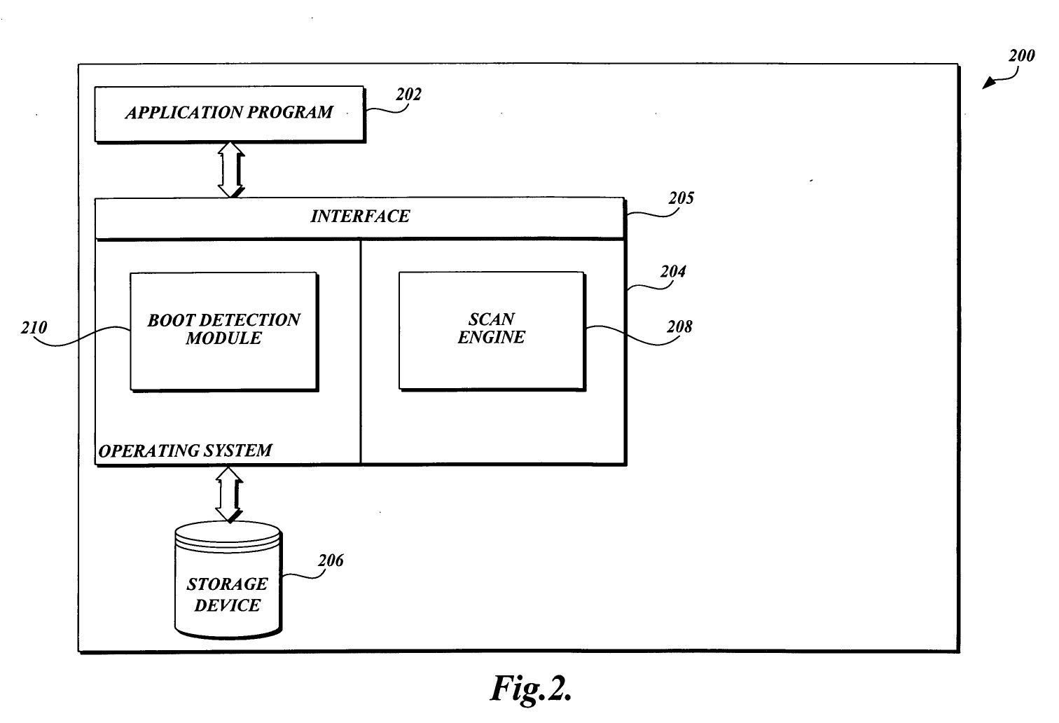

Now with reference to FIG. 2, a computer 200 with components that implement aspects of the present invention will be described. Those skilled in the art and others will recognize that the computer 200 may be any one of a variety of devices including, but not limited to, personal computing devices, server-based computing devices, mini- and mainframe computers, laptops, personal digital assistants (“PDAs”), set-top boxes, entertainment and gaming systems, or other electronic devices having some type of memory. The computer 200 illustrated in FIG. 2 contains many of the same components of like-name described above with reference to FIG. 1. In this regard, the computer 200 includes an application program 202, an operating system 204 with an associated interface 205, and a storage device 206. For ease of illustration and because it is not important for an understanding of the present invention, FIG. 2 does not show the typical components of many computers, such as a keyboard, a mouse, a printer, a display, CPU, memory, etc. However, in this embodiment, the computer 200 also includes a scan engine 208 and a boot detection module 210. As described in further detail below, the scan engine 208 and the boot detection module 210 collectively provide a way to identify malware, such as a RootKit, that starts executing before the services provided by traditional antivirus software are available. In this regard, a RootKit or other malware that infects the computer 200 is identified while the computer is being booted so that the RootKit is unable to continue to conceal data that is characteristic of malware.

The operating system 204 illustrated in FIG. 2 may be a general-purpose operating system such as a Microsoft® operating system, UNIX® operating system, or Linux® operating system. Also, the operating system 204 may be configured to use non-generic hardware designed for specialized computer systems. In any event, as known to those skilled in the art and others, the operating system 204 controls the general operation of the computer 200 and is responsible for management of hardware and basic system operations as well as executing application programs. More specifically, the operating system 204 insures that computer programs, such as the application program 202, are able to use resources like the storage device 206. Modem computers allow application programs to extend the functionality of the operating system 204 by providing mechanisms for code to execute in the memory space reserved for the operating system 204. The problem with these types of systems is that a RootKit or other malware may be able to compromise the integrity of the data provided by the operating system 204 to application programs such as antivirus software. As a result, a RootKit is able to implement obfuscation techniques that prevent antivirus software from identifying the RootKit and/or any other associated malware.

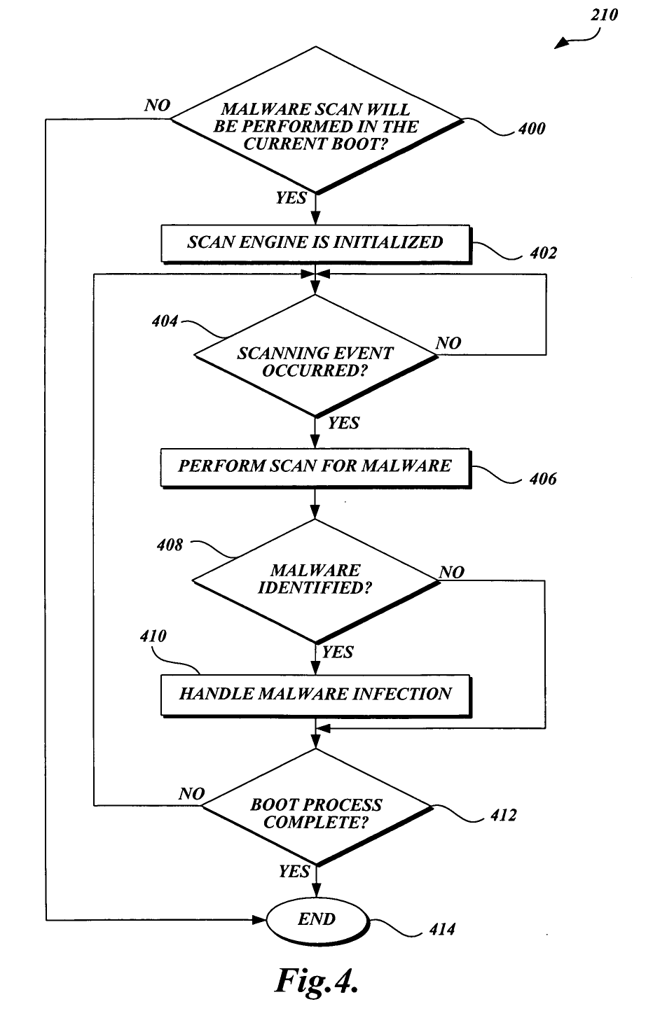

Those skilled in the art and others will recognize that a RootKit typically adds itself to Auto Start Extensibility Point (hereinafter “ASEP”) on a computer. Generally described, ASEPs refer to extensibility points that allow programs to begin executing without explicit user invocation. As a result of being added to an ASEP, a RootKit may begin executing during the boot process, once a user performs a “login,” or sometime thereafter. Typically, antivirus software uses services provided by an operating system to search for malware and may only protect a computer once the services provided by the operating system are available. As a result, a RootKit that infects an operating system or other low-level component of a computer before the services of the operating system are available may be able to conceal data that is characteristic of malware. In one embodiment of the present invention, a boot detection module 210 is provided that causes malware to be identified before the services provided by an operating system are available. Since various aspects of the boot detection module 210 are described in further detail below with reference to FIG. 4, a detailed description of the boot detection module 210 will not be provided here. However, generally described, the boot detection module 210 causes the scan engine 208 to be loaded into memory and executed during the boot process. If malware is identified, the malware may be removed from the computer or the malware may be “quarantined” so that antivirus software may handle the infection once the computer has booted.

As further illustrated in FIG. 2, the computer 200 also includes a scan engine 208 for determining whether data in computer memory is characteristic of malware. Any currently existing or yet to be developed techniques may be used by the scan engine 208 to identify malware that starts executing before services provided by the operating system 204 are available. In this regard, the scan engine 208 may employ integrity checking to verify whether program code that implements the operating system is digitally signed by a trusted entity such as an operating system provider. Moreover, the scan engine 208 may search for suspicious activities such as jump instructions in unexpected locations, hidden processes, references to memory addresses that are outside of a range allocated to the operating system 204, and the like. For example, some operating systems maintain a data structure, sometimes referred to as a process table, with a list of programs that are currently executing. Removing an entry from a process table or a similar data structure may be a strong heuristic indicator that a RootKit is present. Also, the scan engine 208 may employ traditional signature-based techniques in a boot environment to detect malware. In this regard, file data that implements a malware may be identified by matching patterns within the data to what is referred to as a “signature” of the malware. In this instance, data that is known to implement a malware, or a characteristic subset of the data, is processed with a function that converts the data into a signature which uniquely identifies the malware. Once a signature for the malware is available, the scan engine 208 may search data in the memory for a match.

As known to those skilled in the art and others, FIG. 2 is a simplified example of one computer 200 capable of implementing aspects of the present invention. Actual embodiments of the computer 200 will have additional components not illustrated in FIG. 2 or described in the accompanying text. Also, FIG. 2 shows one component architecture capable of performing a search for malware in a boot environment. Thus, the software components illustrated in FIG. 2 should be construed as exemplary and not limiting

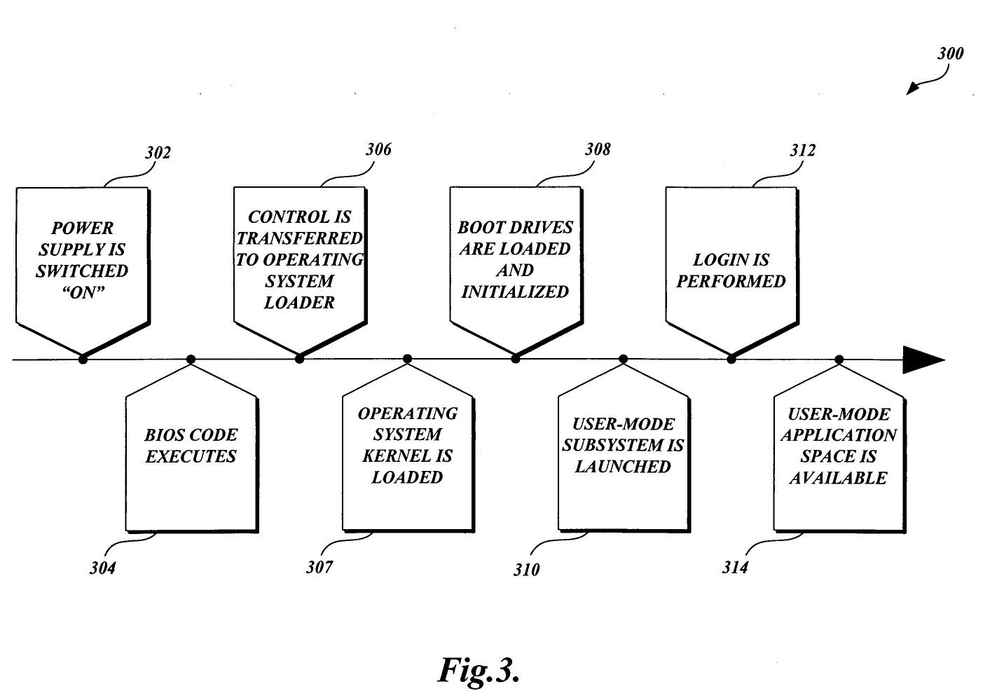

Now with reference to FIG. 3, an exemplary timeline 300 that illustrates events performed when a computer is booted will be described. Those skilled in the art and others will recognize that the timeline 300 is a highly simplified example of a generalized and non-exclusive set of events that may occur at computer start up. In other embodiments, additional or fewer events may occur or events may occur in a different order than the description provided below. Thus, the timeline 300 illustrated in FIG. 3 is merely illustrative and should be construed as exemplary.

As illustrated in FIG. 3, at event 302 a power supply is switched “on” so that power is applied to the computer. When sufficient power is available, a CPU begins executing Basic Input/Output System (“BIOS”) code, at event 304. The BIOS code contains computer instructions that enable the computer to perform functions for initializing the computer's hardware. Typically, once a computer is powered on, the computer's BIOS conducts a hardware check, commonly referred to as a Power-On Self Test (POST) to determine whether the support hardware is present and working correctly. Those skilled in the art and others will recognize that the BIOS is typically located in non-volatile memory to ensure that the BIOS is always available and will not be damaged by failures affecting volatile memory or mass data storage. Moreover, those skilled in the art and others will recognize that a BIOS provides low-level input/output control. For example, in a personal computer, the BIOS contains the computer instructions required to control the keyboard, display screen, disk drives, perform basic input/output (“I/O”), and other miscellaneous functions.

At event 306, instructions in the BIOS direct control to an operating system loader. Typically, the operating system loader performs hardware detection, loads the operating system into a computer's volatile memory, e.g., a bank of random access memory (RAM) memory devices, and begins initializing the operating system. At event 307, the operating system “kernel” is loaded and is available to provide services to other components. In this regard, initialization of a component of the operating system known as an I/O manager initiates the process of loading and initializing boot drivers, at event 308. In this regard, a prioritized list of the boot drivers is assembled by the I/O manager and each driver on the list is loaded into memory. Boot drivers typically provide services that enable optimized access to the resources of hardware devices such as video cards, printers, disk drives, and the like. Once all of the boot drivers have been loaded, the user mode subsystem is launched, at event 310. Generally described, the user mode subsystem provides support services to the user mode application space. In this regard, launching the user mode subsystem may include establishing a local security authority and eventually presenting a “login” prompt to the user. At event 312, a login is performed and user mode services are made available. For example, Server Message Block (“SMB”) is a protocol for sharing files, printers, serial ports, and communication abstractions between computers that becomes available when the login is performed. Once the user mode services are available, at event 314, the user-mode application space may be accessed to execute programs. Once event 314 is reached, programs designed to perform specific tasks on a general purpose computer may be executed. In this regard, when a program is selected for execution in the user mode application space, an operating system may cause program code associated with the selected program to be loaded from a storage device (e.g., hard drive) into memory where the program code is accessible to a CPU.

As described in further detail below, aspects of the present invention cause a search for malware to be performed during the boot process. More specifically, at any number of different locations in the timeline 300, a software module (e.g., the scan engine 208) may be loaded into memory. Then, a search for data that is characteristic of malware may be performed. In this regard, components that execute during the boot process may be continually scanned until traditional antivirus software is available to protect the computer once the boot process is complete.

Depending on the configuration of the computer, aspects of the present invention may be implemented in a BIOS, operating system loader, or boot driver. In this regard and as illustrated FIG. 3, the scan engine 208 may be loaded into memory and begin executing at events 304, 306, or 310. Generally stated, it is desirable to start scanning for malware as early as possible in the boot process to prevent malware that infects a previous component from having the opportunity to implement obfuscation techniques. However, even if a malware is able to implement obfuscation techniques during the boot process, the resources available to the malware may not be sufficient to avoid detection. In this regard, a boot environment is restricted and the ability of a malware to conceal itself and/or perform malicious acts on a computer that implements the present invention is limited.

The location in the timeline 300 or boot process where protection from malware is provided may depend on the configuration of the computer. For example, those skilled in the art and others will recognize that computer vendors may each provide a different BIOS for initializing the hardware on a computer. Thus, services provided by the BIOS may not be standardized so that a single implementation of the present invention could be provided regardless of the computer platform. Stated differently, implementing aspects of the present invention in the BIOS may more readily be performed if the services provided by the BIOS are standardized across computer platforms. More generally, the location in the boot process where the scan engine 208 is loaded into memory and begins executing may depend on any number of factors that affect how a computer can be configured.

Now with reference to FIG. 4, an exemplary boot detection module 210 mentioned briefly above with reference to FIG. 2 will be described in more detail. Generally described, the boot detection module 210 provides a way to identify malware, such as RootKit, that becomes active during the boot process. By becoming active during the boot process, a malware is more readily able to implement obfuscation techniques to filter data that is communicated to traditional antivirus software. As an initial matter, prior to the boot detection module 210 being executed, a power supply is switched “on” so that power is available to the computer.

As illustrated in FIG. 4, the boot detection module 210 begins at block 400 where a determination is made regarding whether one or more scans for malware will be performed in the current boot. As mentioned previously, when power is applied to a computer, a sequence of events occur that cause the computer to boot. In one embodiment, the boot detection module 210 may be configured to scan for malware each time the computer is booted. However, depending on the techniques used, scanning for malware may be a resource-intensive process. Thus, in other embodiments, a scan for malware is selectively performed based on whether a prerequisite was satisfied to minimize the use of computer resources.

A first prerequisite that may be used to differentiate between instances when a scan for malware will or will not be performed is the identification of “suspicious” activity. Antivirus software may identify activity that could be characteristic of malware but have insufficient information to definitively declare that a malware infection exists. In this instance, a computer or computer network may transition into a heightened state in which extensive searching for malware is conducted. The transition to the heightened state may cause a scan for malware to be performed during each boot of a computer. In this regard, a variable that persists across boots may be set when the suspicious activity is identified to indicate that a scan for malware will be performed at computer start up. In this instance, the boot detection module 210 checks the value of the variable, at block 400, to determine whether a scan for malware will be performed.

Another prerequisite that may be used to differentiate between instances when a scan will or will not be performed is based on user input. In this regard, controls may be integrated into antivirus software that enable a user to generate input that causes a scan for malware to be performed during the boot process. Also, a user may be prompted during the boot process to provide input regarding whether scan should be performed. Similar to the description provided above, a variable that persists may be set when the appropriate user input is received to indicate that a scan will be performed.

By way of additional examples, a scan for malware may be scheduled automatically without the identification of suspicious activity or receipt of user input. In this regard, aspects of the present invention may be configured to perform a scan for malware at regular intervals such as every five (5) times the computer is booted, or other arbitrarily established value. Moreover, the determination as to whether a scan for malware will occur may be made randomly. For example, those skilled in the art and others will recognize that a hardware device such as an Advanced Programmable Interrupt Controller (“APIC”) may be used to generate a random value. In this regard, a determination as to whether a scan for malware will be performed in the current boot may be based on this value. If a determination is made at block 400 that a scan for malware will not be performed since the appropriate prerequisite was not satisfied, the boot detection module 210 proceeds to block 414, where it terminates. Conversely, if a determination is made that a scan will be performed, the boot detection module 210 proceeds to block 402.

At block 402, the scan engine 208 (FIG. 2) is initialized and starts executing at a predetermined location in the boot process. As mentioned previously, aspects of the present invention may start searching for malware at potentially different locations as a computer is being booted. In this regard, program code that implements the present invention may be integrated into a BIOS, an operating system loader, or boot driver. As a result, the initialization of the scan engine 208, at block 402, may occur at different locations in the timeline 300 (FIG. 3). Moreover, initialization of the scan engine 208 may, and typically will, be assigned the highest priority within the component in which it is integrated. For example, as mentioned previously, a prioritized list is used to identify the order in which boot drivers are initialized. If the scan engine 208 is initialized by a boot driver, the boot driver is assigned the highest priority when compared to other boot drivers. As a result, subsequently initialized boot drivers are scanned for malware as they are loaded into memory. In this way, the possibility that a malware could conceal itself during the boot process is minimized.

As illustrated in FIG. 4, at decision block 404, the boot detection module 210 remains idle until a scanning event occurs. In one embodiment, a scan for malware is automatically performed as soon as the scan engine 208 is initialized. However, scanning events may be defined that cause additional scans for malware to be performed during the boot process. Similar to an “on-access” scan performed by existing antivirus software, each piece of software loaded into memory during the boot process may be scanned by the scan engine 208 before being allowed to execute. For example, as each boot driver is loaded into memory, at event 310 (FIG. 3), a scanning event may be generated so that the boot driver is scanned for malware. Moreover, those skilled in the art and others will recognize that scanning events may be generated in other instances once the scan engine 208 is initialized without departing from the scope of the claimed subject matter.

Upon a scanning event being identified, the boot detection model 210 causes a scan for malware to be performed at block 406. As mentioned briefly above with reference to FIG. 2, any currently existing or yet to be developed techniques may be used to search for malware. In this regard, the scan engine 208 may implement an integrity check to determine whether program code in the memory address space allocated to the operating system originated from a trusted entity. Also, in addition to an integrity check, it is contemplated that signature-based techniques and/or search for “suspicious modifications” may be performed in the scan.

In one embodiment, the scan performed at block 406 searches for a subset of the known malware. As mentioned previously, scanning for malware may be a resource-intensive process. Moreover, the services requested by the scan engine 208 when performing a scan may not be satisfied quickly in a boot environment when compared to a non-boot environment. In this regard, performing a scan for all known malware in a boot environment may negatively impact the user experience. Thus, a scan may be performed, at block 406, to identify the type of malware that is most likely to start executing in a boot environment (e.g., RootKits). However, those skilled in the art and others will recognize that this is merely an optimization technique and should not be construed as limiting on the claimed subject matter. Then, at decision block 408, a determination is made regarding whether malware was identified as a result of the scan performed at block 406. If a malware was not identified, the boot detection module 210 proceeds to block 412, described in further detail below. Conversely, if a malware infection was identified, the boot detection module 210 proceeds to block 410.

As illustrated in FIG. 4, at block 410, the boot detection module 210 causes the malware infection to be handled. If block 410 is reached, data characteristic of malware was identified during the boot process. In one embodiment, handling the infection at block 412 includes attempting to remove the malware from the computer by killing processes, deleting files, removing entries in configuration files that are associated with the malware, and the like. However, since the resources available in a boot environment are limited, successfully removing all components of a malware, at block with 412, may be difficult or impossible. For example, some malware implement self-preservation techniques in which the malware's resources (e.g., files, processes, entries in configuration files, and the like) are monitored. When an attempt to remove the malware is identified, functionality designed to preserve the malware's resources and maintain the infection are performed. Thus, handling the malware infection may also include “quarantining” the component of the malware that is active in the boot environment. In this regard, a “stub” module may be used as a placeholder for the malware. For example, the stub module may be configured to sustain a malware process, accept and/or return valid data in response to being called, or perform any other action to prevent triggering of a malware self-preservation technique. In this embodiment, when the malware is quarantined, data will typically be communicated to antivirus software that executes once the computer boots so that all of the components of the malware may be removed.

As illustrated in FIG. 4, at block 412, a determination is made regarding whether the computer successfully booted. As mentioned previously, aspects of the present invention identify malware that becomes active in a boot environment, before traditional antivirus software is able to provide protection. However, once the boot process is complete and traditional antivirus software is available. Functionality by the present invention is dormant until the boot process is again initiated. When the boot process is complete, the boot detection model 210 proceeds to block 414, where terminates. However, if a determination is made at block 412 that the boot process is not complete, the boot protection module proceeds back to block 404, and blocks 404-412 repeat until the boot process does complete.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a computer that employs a boot process at computer start up, a computer-implemented method of identifying malware that becomes active during the boot process, the method comprising:
(a) causing a software module that is configured to perform a scan for malware to be initialized during the boot process;
(b) in response to identifying the occurrence of a scanning event:
(i) causing the software module to scan computer memory for data that is characteristic of malware; and
(ii) if data characteristic of malware is identified, handling the malware infection.

2. The method as recited in claim 1, wherein the software module that is configured to perform a scan for malware is initialized at the stage in the boot process in which the BIOS executes.

3. The method as recited in claim 1, wherein the software module that is configured to perform a scan for malware is initialized at the stage in the boot process in which the operating system loader executes.

4. The method as recited in claim 1, wherein the software module that is configured to perform a scan for malware is implemented in a boot driver.

5. The method as recited in claim 1, wherein scans for malware are selectively performed at computer start up when a prerequisite is satisfied.

6. The method as recited in claim 5, wherein user input is the prerequisite used to determine whether a scan will be performed during the current boot.

7. The method as recited in claim 1, wherein the scan for malware is selectively performed at regularly scheduled boots of the computer.

8. The method as recited in claim 1, wherein scans for malware are performed at randomly selected boots of the computer.

9. The method as recited in claim 1, wherein causing the software module to scan computer memory for data that is characteristic of malware includes comparing data in memory with signatures that are associated with malware.

10. The method as recited in claim 1, wherein causing the software module to scan computer memory for data that is characteristic of malware includes performing an integrity check to determine whether program code in the memory space allocated to the operating system originates from a trusted entity.

11. The method as recited in claim 1, wherein the scan is configured to identify a subset of all known malware that are likely to be active in a boot environment.

12. The method as recited in claim 1, wherein handling the malware infection includes killing processes, deleting files, and removing entries in configuration files that are associated with the malware.

13. The method as recited in claim 1, wherein handling the malware infection includes using a stub module as a placeholder to prevent triggering of a malware self-reservation technique.

14. A computer-readable medium containing computer-readable instructions which, when executed in a computer that implements a boot environment at start up, performs a method of determining whether the computer is infected with malware, the method comprising:
(a) integrating a malware scan engine into a component of the boot environment;
(b) determining whether a scan for malware will be performed during the current boot; and
(c) if a determination is made that a scan for malware will be performed during the current boot, causing the scan engine to search components of the boot environment for malware.

15. The computer readable-medium as recited in claim 14, wherein the malware scan engine is integrated into a BIOS, operating system loader, or boot driver.

16. The computer readable-medium as recited in claim 14, wherein the determination whether a scan for malware will be performed during the current boot is made by receiving user input in response to a prompt.

17. The computer readable-medium as recited in claim 14, wherein causing the scan engine to search components of the boot environment for malware includes searching for suspicious activity characteristic of RootKit.

18. The computer readable-medium as recited in claim 17, wherein performing the search for suspicious activities that are characteristic of RootKit includes:
(a) identifying jump instructions in unexpected locations;
(b) identifying processes that are hidden; and
(c) identifying references to memory addresses that are outside of a range allocated to the operating system.

19. A computer-readable medium having computer executable components for identifying malware in a boot environment, comprising:
(a) a scanning component configured to search computer memory for data that is characteristic of malware;
(b) a boot detection component for initializing the scanning component during the boot process; and
(c) an optimization component that causes the scanning component to search memory for a subset of known malware.

20. The computer readable-medium as recited in claim 19, wherein the boot detection component is further configured to handle the malware infection by replacing malware program code with a stub module.
